(19) United States
(12) Patent Application Publication
(10) Pub. No.: US 2021/0181841 A1
(43) Pub. Date: Jun. 17, 2021

(54) INTEGRATIVE HAND-WEARABLE APPARATUS AND SYSTEMS

(71) Applicant: Trechrein LLC, St. louis, MO (US)

(72) Inventor: Antonio J Gates, st. Louis, MO (US)

(73) Assignee: Trechrein LLC, St. louis, MO (US)

(21) Appl. No.: 17/123,107

(22) Filed: Dec. 16, 2020

Related U.S. Application Data
(60) Provisional application No. 62/948,483, filed on Dec. 16, 2019.

(51) Int. Cl. G06F 3/01; H04W 4/30; H04W 4/029

(52) U.S. Cl. CPC G06F 3/014; H04W 4/029; H04W 4/30; G06F 3/016

(57) ABSTRACT

The present disclosure relates to an integrative apparatus and systems, wherein the wearable is touch-sensitive hand-wearable and can communicate with a variety of electronic devices, non-wearables, wearables, or any combination thereof. The touch-sensitive hand-wearable apparatus and systems are used by a biker, motorcyclist, other riders, and non-riders. This invention provides a system and device for communication, management, manufacture, and methods thereof.

### CROSS-REFERENCE TO RELATED APPLICATIONS

Application is a Non-Provisional Application claiming priority of the Provisional U.S. Application No. 62/948,483 filed on Dec. 17, 2019, and is incorporated in entirety herein. This application is a continuation-in-part of the non-provisional application Ser. No. 16/935,067 with the priority of Jul. 23, 2019, and is incorporated in entirety herein by reference.

### STATEMENT REGARDING FEDERALLY SPONSORED RESEARCH OR DEVELOPMENT

Not Applicable.

The present disclosure relates to an integrative apparatus and systems, wherein the wearable is touch-sensitive hand-wearable and can communicate with other wearable and non-wearable devices and technologies.

### BACKGROUND

A touch-sensitive hand-wearable apparatus and systems for the biker, motorcyclist, and other riders are needed but are lacking. This invention provides a system and device for communication, management, and methods thereof.

### BRIEF DESCRIPTION OF THE INVENTION

The hand-wearable apparatus may be made of an electrically conductive material such that the device covers completely or partially a hand for the best comfort and functionality and may contain a controller or micro-controller. The hand-wearable may be made so that it is unincorporated, partially incorporated, fully incorporated into a hand-wear, an arm clothing, jewelry, or any combination thereof. The hand-wearable device, incorporated or unincorporated, may be flexible, stretchable, or bendable such that one size fits most or all hand sizes. The communication between the hand-wearable and the controller can be wired or wirelessly. The controller may be 0-5 feet away from the hand-wearable device.

The hand-wearable device may be mounted onto the handlebar of the bike, motorbike, the car steering, pet reins/leash, hand remote-control, air-sports hand-devices, athletic sports hand-devices, security hands-devices, emergency hand-devices, etc.

The hand-wearable functioning may be related to a new and unique type of touch-sensitivity technologies without sensors of traditional touch-sensitive technologies. An electrical signal may be sent to activate and turn-on pre-determined settings of various wearables and non-wearable devices. The functionality may be when the device covered two fingers touching each other. The hand wearable device may be mounted on the handlebar; the electrical signal may be sent when the wearable device covered finger(s) may touch the mounted device to turn the switch ON/OFF.

The hand-wearable device may have one or more kill switches to conserve battery charge. The hand-wearable device may communicate wirelessly with other wearables technologies such as electrical, electronics, microelectronics, nano electronics, internet of things, computer systems, etc. The wearables may be selected from a vest, jacket, legwear, pants, headwear, neckwear, socks, shoes, footwear, jewelry, and any combination thereof. The hand-wearable may communicate wirelessly with other electronic devices such as, but not limited to, a speaker, microphone, the cellular phone, the camera, vehicles, and any combination thereof. The hand-wearable device may communicate wirelessly with wearables on pets such as, but not limited to, dogs, cats, horses, rabbits, ferrets, bovine, pigs, rodents, hamsters, gerbils, chinchillas, rats, and Guinean pigs.

The hand-wearable device may be weather resistance-, water-, temperature-, humidity-resistance or -proof, or any combination thereof. The wearable may be re-charged via wired mode, wireless mode, solar mode, or a combination of any modes. The device may have 1 to 10 channel receivers, which may be wired, wireless, or a combination thereof. The device may be trackable and may be linked, controlled, or both by an app/APP. The device may function without touch-sensitive sensors.

### BRIEF DESCRIPTION OF DRAWINGS

FIG. 1: An aspect of the hand-wearable device.

FIG. 2: Functional aspect of the hand-wearable device.

FIG. 3: Aspects of the mountable device.

FIG. 4 One size fits all hand sizes.

FIG. 5: One size fits all hand sizes with a functional aspect of a hand-wearable device.

FIG. 6: Shown here is communication via the hand-wearable.

### DETAILED DESCRIPTION OF THE INVENTION

Examples embodiments are provided so that this disclosure will be thorough and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components but do not preclude the presence or addition of one or more other features, integers, steps, operations, elements, components, and/or groups thereof. The method steps, processes, and operations described herein are not to be construed as necessarily requiring their performance in the particular order discussed or illustrated unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer, or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The preceding summary, as well as the following detailed description of certain embodiments, will be better understood when read in conjunction with the appended figure of experimental data and results. As used herein, an element or step recited in the singular and proceeded with the word “a” or “an” should be understood as not excluding the plural of said elements or steps unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. When a definition is provided herein, it supersedes any other meaning or definition.

As used herein, the term “hand-wearable” means a wearable that can be worn by or on a hand or a part of the hand.

As used herein, the term “touch-sensitive of the hand-wearable” means that when two parts of the wearable device touch another part of the same hand wearable to activate or operate the hand wearable device.

As used herein, the term “wearable” means that which can be attached to or worn by a human or non-human vertebrate.

As used herein, the term “presetting” means a setting wherein an event is preset to occur.

As used herein, the term “technology” means apparatus, devices, smart devices, electrical equipment, microelectronics, electronics, computer, hardware, software, instruments, machinery, and equipment.

This invention relates to a hand-wearable that is touch-sensitive and integrable to other devices, wearables, vehicles, etc. The invention provides for a unique and novel combination of the touch-sensitive and integrable wearable and apparatus and systems. Described herein is an apparatus and system that may be used by a variety of rides, drivers, and others to safely, carefully, and efficiently communicate with other electronic devices and wearable. The communication may be uni-, bi-, multi-directional, or any combination thereof. Riders, vehicle-drives, security-worker, emergency-workers, athletes, air sports-personnel, etc., or anyone who needs hands-free regulation and management of electronic, electrical, smart-devices, and other devices and wearables may use this invention for safe and effective regulation of these electronic, electrical, smart-devices, and other devices. The other wearables and devices can be smart, incorporated with electrical, electronics, microelectronics, nanoelectronics, internet of things, computer systems, others, and any combination thereof. Although the hand-wearable may use touch-sensitive technology, the integrated devices can utilize one or more human or animal senses such as vision, touch, voice, smell, and taste.

In an embodiment of the invention, the hand-wearable may be made of an electrically conductive material such as pure or alloys of bronze, copper, silver, gold, aluminum, brass, nickel, zinc, or any combination thereof.

In an embodiment of the invention, the hand-wearable may be made so that it covers entirely or partially a hand. This device may be comfortable and fully functional and cover hands fully or partially hands, e.g., cover fingers and thumb only or additionally cover complete or partial palms, wrist, arm, and/or any combination thereof.

In an embodiment of the invention, the hand-wearable may be made such that it may cover completely or partially fingers and thumb such that the device is comfortable and fully functional. For example, it may cover finger-ring size, half phalanx(s), ¼ phalanx(s), full-phalanx(s), one finger, two fingers, three fingers, four fingers, five fingers on one hand, or other hands with 1-5 fingers of another hand.

In an embodiment of the invention, the hand-wearable may be made such that it is unincorporated, partially incorporated, fully incorporated into fingers, hand, wrist, palms, or arm clothing or jewelry (e.g., gloves, sleeves, rings, bracelet, etc.) and/or any combination thereof.

In an embodiment of the invention, the hand-wearable may be regulated by a controller, micro-controller, nano-controller, and/or any combination thereof.

In an embodiment of the invention, wherein the hand-wearable may be mounted onto a handlebar of the bike, motorbike, the car steering, one, two, three, four, five, six, seven, eight, nine, or ten wheeled vehicles, pet reins/leash, hand remote-control, air-sports hand-devices, athletic sports hand-devices, security hands-devices, emergency hand-devices, etc., or any combination thereof.

In an embodiment of the invention, the hand-wearable may communicate via wires with the controller, micro-controller, nano-controller, or any combination thereof.

In an invention's embodiment, the hand-wearable may communicate wirelessly with the controller, micro-controller nano-controller, any combination thereof.

In an embodiment of the invention, the controller, micro-controller, or nano-controller may be present on one or both hands, another body part, other clothing of the same person, within 0-0.5, 0-1, 0-2, 0-3, 0-4, or 0-5 feet diameter of the hand wearable device or any combination thereof.

In an embodiment of the invention, wherein the hand-wearable may control communication via finger touching two or more fingers of the same wearable, on the same hand, the other hand, or any combination thereof.

In an embodiment of the invention, the hand-wearable may control communication via finger touching another device mounted on the handlebar of the bike, motorbike, the car steering, one, two, three, four, five, six, seven, eight, nine, or ten wheeled vehicles, pet reins/leash, hand remote-control, air-sports hand-devices, athletic sports hand-devices, security hands-devices, emergency hand-devices, or any combination thereof.

In an embodiment of the invention, the hand-wearable wearable may be flexible, stretchable, and/or bendable such that one size fits all hands.

In an embodiment of the invention, wherein the hand wearable or another device may have one or more kill switches to conserve battery charge. The kill switch may completely shut the power from the batteries to the device or almost (partially) completely shut the energy from the batteries to the device such that the device can be remotely turned on.

In an embodiment of the invention, wherein the hand-wearable, other wearables, and/or device may communicate wirelessly with technologies on wearables such as electrical, electronics, microelectronics, nanoelectronics, internet of things, smartphone, computer systems, etc., or any combination thereof. The other wearable maybe a vest, jacket, legwear, pants, headwear, neckwear, socks, shoes, footwear, jewelry, or any combination thereof.

In an embodiment of the invention, wherein the hand-wearable, another wearable, or device may communicate wirelessly with other electronic devices such as a speaker, microphone, the cellular phone, the camera, vehicles, (e.g., staring-wheel, handlebar, brakes, lights, electronic systems, electrical systems, sensors, floor components car seat, powertrain and chassis, braking system, electrified powertrain components, engine components, engine cooling system, engine oil systems, headlights, bumper cover, car fender, radiator support, catalytic converter, car mirror, car hood, step bumper, lower control arm, tail light, window regulator, fuel pump replacement, car body and main part body components, including trim, bonnet/hood, bonnet/hood, bumper, unexposed bumper, exposed bumper, cowl screen; decklid, suspension and steering systems, transmission system, air conditioning system, bearings, hose, charging docks, etc.), one, two, three, four, five, six, seven, eight, nine, or ten wheeled vehicles, artificial intelligence hardware, software, training data, collected data, etc., or any combination thereof.

In an embodiment of the invention, wherein the hand-wearable, another wearable, device may communicate wirelessly with wearables on animals such as, but not limited to, pets are dogs, cats, horses, rabbits, ferrets, bovine, pigs, rodents, hamsters, gerbils, chinchillas, rats, Guinean pigs, etc., and any combination thereof.

In an embodiment of the invention, wherein the hand-wearable, another wearable, or device may communicate wirelessly with other wearables and apparatus.

In an embodiment of the invention, wherein the hand-wearable, another wearable, or device may be weather resistance-, water-, temperature-, humidity-resistance, or any combination thereof.

In an embodiment of the invention, wherein the hand-wearable, another wearable, or device may be weatherproof, waterproof, temperature-proof, humidity-proof, or any combination thereof.

In an embodiment of the invention, wherein the hand-wearable, another wearable, or device may communicate wirelessly with a speaker to deliver voice command instruction to other electronic or wearable devices.

In an embodiment of the invention, wherein the hand wearable may have sensors such as pressure sensors (not needed to function but for additional functions), temperature, humidity, moisture, heart-rate, etc., and any combination thereof.

In an embodiment of the invention, wherein the hand-wearable, another wearable, or device may be re-charged via wired mode, wireless mode, solar mode, or a combination of any modes.

In an embodiment of the invention, wherein the hand-wearable, another wearable, or device may have 1 to 2, 3, 4, 5, 6, 7, 8, 9, or 10 channels receivers, which may be wired or wireless or a combination thereof.

In an embodiment of the invention, wherein the hand-wearable, another wearable, or device may be trackable. The tracking device may be tracked via micro-GPS, nano-GPS, SOS, sound, and light signals.

In an embodiment of the invention, wherein the hand-wearable, another wearable, or device may be linked, controlled, or both by an app/APP.

In an embodiment of the invention, wherein the hand-wearable, another wearable, or device may have a micro-USB or a USB port.

In an embodiment of the invention, wherein the wrist strap with soft Velcro or strap buckle, 110, maybe 8 to 15 inches long, 8, 8.5, 9, 9.5, 10, 10.5, 11, 11.5, 12, 12.5, 13, 13.5, 14, 14.5, 15 inches long.

In an embodiment of the invention, wherein the wrist reflective strap with soft Velcro or strap buckle. 109, 0.1 to 1 inch wide, 0.1, 0.15, 0.2, 0.25, 0.3, 0.35, 0.4, 0.45, 0.5, 0.55, 0.6, 0.65, 0.675, 0.7, 0.75, 0.775, 0.8, 0.85, 0.875, 0.9, 0.95, 0.975, 1 inches wide.

In an embodiment of the invention, wherein the controller box, 109, maybe 1 to 3 inches long by 0.5 to 1.5 inches wide by 0.1 to 0.5 inches high.

In an embodiment of the invention, wherein the wires, 105 to 108, connecting brass rings to the controller box maybe 5 to 10 inches long, 5, 5.5, 6, 6.5, 7, 7.5, 8, 8.5, 9, 9.5.10 inches long.

In an embodiment of the invention, wherein the brass thumb ring/loops, 101 to 104, is 1 to 3 inches, 1.5, 2, 2.5, 3 inches, and 0.5-1.0 inches perimeter. 0.55, 0.6, 0.625, 0.65, 0.675, 0.7, 0.725, 0.75, 0.775, 0.8, 0.85, 0.9, 0.95, 1.0 inches perimeter.

In an embodiment of the invention, wherein the brass finger ring/loops, 102 to 104, 1.0 to 3 inches, 1.5, 2, 2.5, 3 inches, and 2 inches perimeter.

### DETAILED DESCRIPTION OF THE DRAWINGS

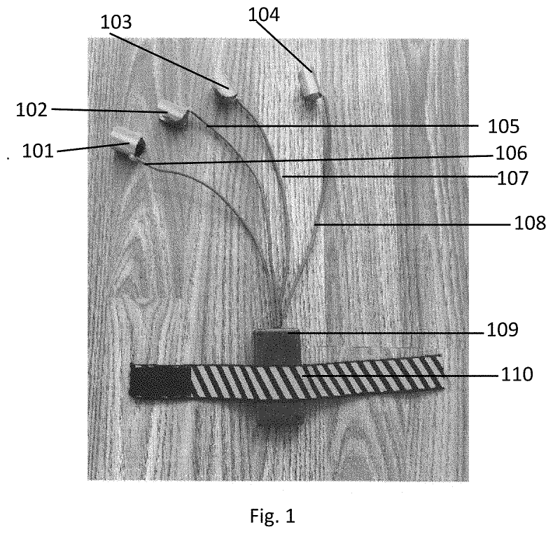

FIG. 1: An aspect of the hand-wearable device. Shown here is a four-channel 101-104 device connected to a controller 109 via wires 105-108. The controller is attached to a wrist band 110, which could be replaced by a bracelet, clothing, or jewelry (hand-, arm-, wrist-, neck-, face-, ear-, head-, clothing/jewelry, shirt, pant, back-pack, body-back, vehicle or its parts, etc.). The device can also be wireless, and the controller can be smaller such as a micro-controller.

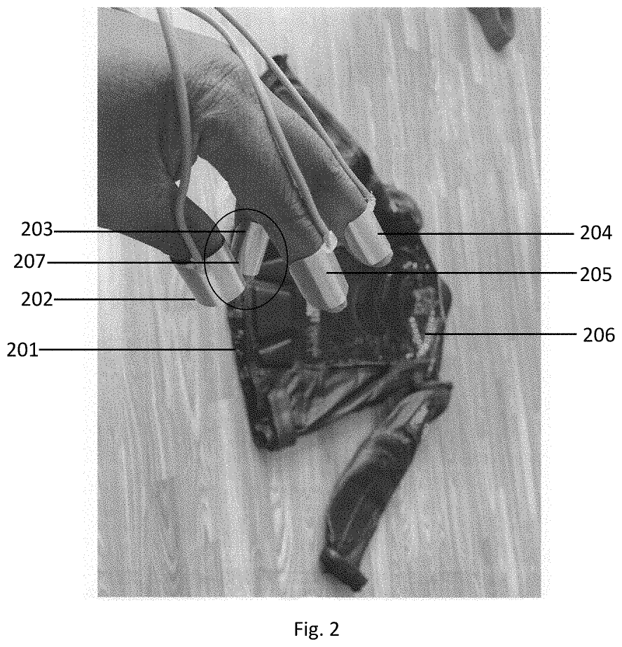

FIG. 2: Functional aspect of hand-wearable device: Shown here is a hand wearable device integrated with a jacket 201 containing lights. As demonstrated, when the thumb 202 connects with another finger, such as the ring finger 203 herein, the lights on the jacket are activated and turned on 206. Herein, the thumb's touching and ring finger is preset to activate and turn on the lights; however, this present signal can be changed to a different outcome. Similarly, the touch between the thumb and the first finger or the middle finger can be preset to perform a different function.

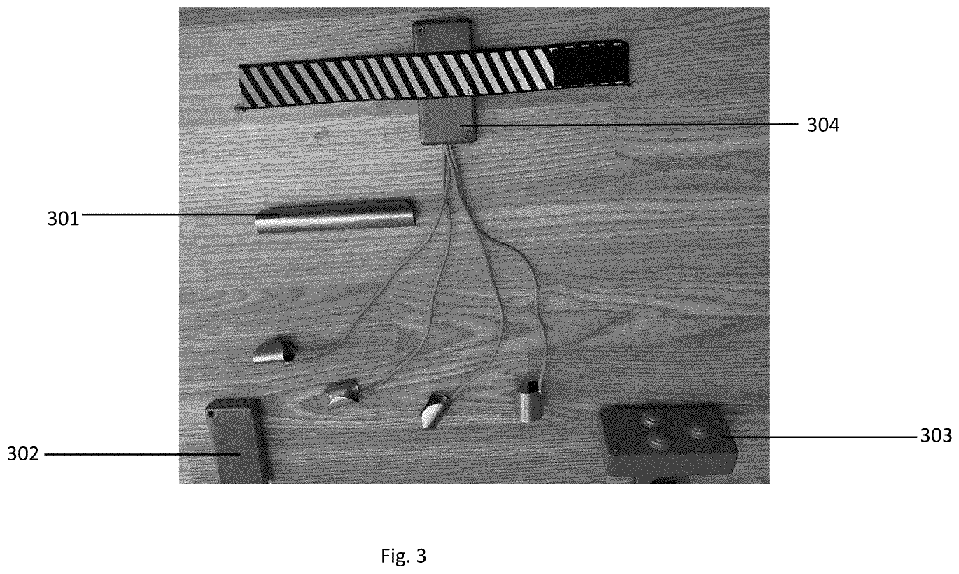

FIG. 3: Aspects of the mountable device: The mountable device can have various forms, and two such forms are shown here in 301 and 303. The controller can be wireless 302 and 304 wired. The device, 303, is 2-3 inches (perimeter) and 5-7 inches long. The wireless remote, 301, is 3.5 inches long by 2 inches wide by 1 inch high.

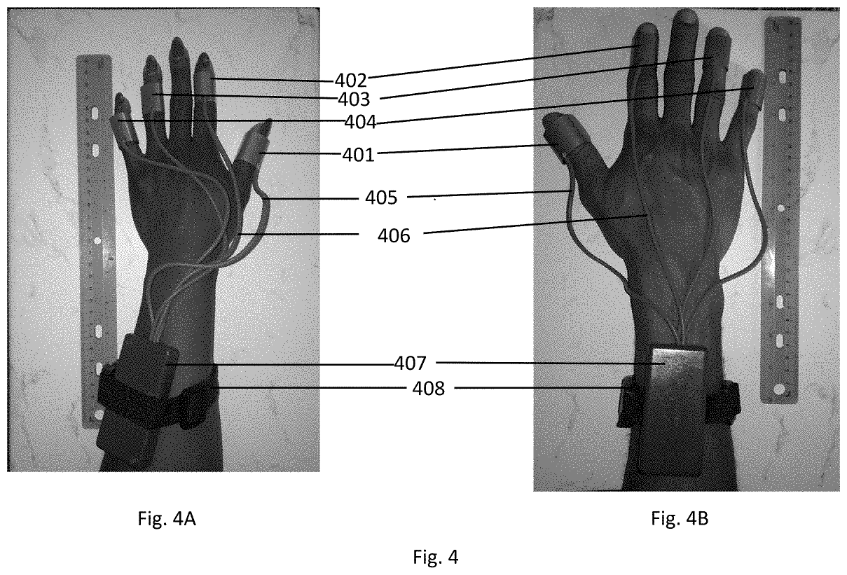

FIG. 4: One size fits all hands. Shown are two hands wearing the device; figure A is a small hand while figure B is a large hand. The thumb loop will always have a piece of material coding/covering the inside of the ring loop. This makes the thumb ring loop the ground and will help to keep the electrical current to its proper level when controlling the devices 401. It is a four-channel 401-404 device connected to a controller 407 via wires 405-406. The controller is attached to a wrist band 408, which could be replaced by a bracelet, clothing, or jewelry (hand-, arm-, wrist-, neck-, face-, ear-, head-, clothing/jewelry, shirt, pant, back-pack, body-back, vehicle or its parts, etc.). The device can also be wireless, and the controller can be smaller such as a micro-controller.

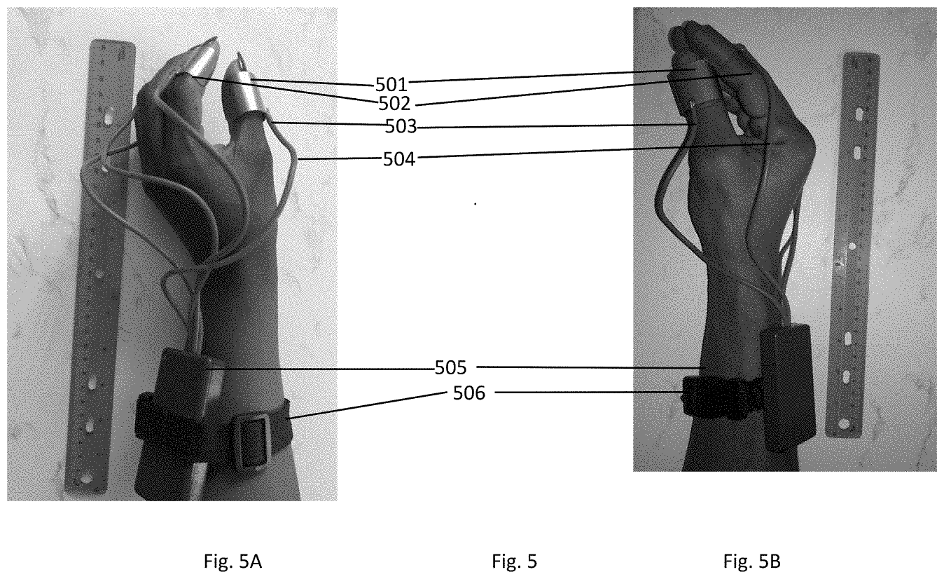

FIG. 5: One size fits all hand sizes with a functional aspect of hand-wearable device: Shown are two hands wearing the device; figure A is a small hand while figure B is a large hand. The thumb loop will always have a piece of material coding/′covering the inside of the ring loop. This makes the thumb ring loop the ground and will help to keep the electrical current to its proper level when controlling the devices 501. Shown herein is, when the thumb 501 connects with another finger, such as the index finger 502 herein, the lights on the jacket are activated and turned ON/OFF. Herein, the touching of the thumb and the index finger is preset to activate and turn on the lights; however, this present signal can be changed to a different outcome. Similarly, the touch between the thumb and the ring finger or the middle finger can be preset to perform a different function.

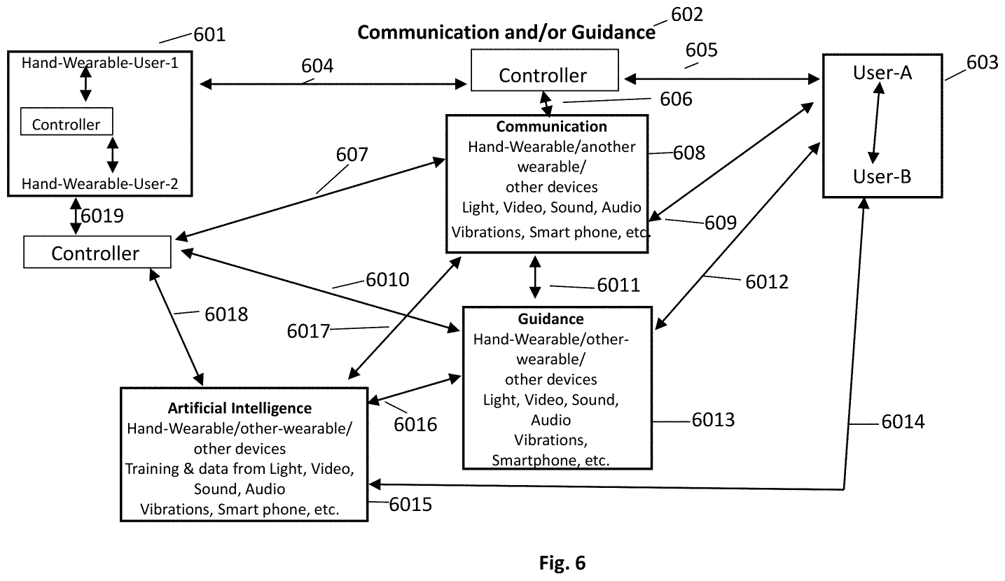

FIG. 6: Shown here is communication via the hand-wearable: The communication may be between one or more hand wearable users and other wearables or device users, 604, 605. The communication may be one or more hand wearable user 601, where one user may communicate via the hand wearable and another device to obtain information, e.g., smartphone or camera. The user may activate and operate the device, such as smartphone, camera, etc., via the hand wearable to get communication (information) and guidance 601, 607, 6010, 6018. The hand wearable may be activated and operated by controller 604, 607, 6010, 6018, 6019. The communication may be uni, bi, or multi-directional. Users A and B may represent non-hand wearable or device users; whereas, users 1 and 2 represent hand wearable users.

### Example 1

A motorcyclist may be lost and may want directions. He may activate his cellular or smartphone using the hand-wearable device and activate the voice command system of his phone to get directions to his destination. He can also use the hand-wearable to turn lights on or off on his illuminating vest, vehicle lights, or both to indicate that he wants to change lanes or stop. He can turn these lights to become more visible to others and to improve his visibility during the dark.

### Example 2

A pet-owner is walking his dogs at night, and one of his several dogs gets lost. Due to his inability to reach for his phone, he can activate tracking devices, lights, noise generating devices, and speakers on dog wearables using his hand-wearable. The owner can find the dog via the tracking devices, including, but not limited to, the lights and noise generating devices. The speakers on the dog wearable can communicate, comfort, and guide the dog.

### Example 3

A motorcyclist is injured during an accident. He is unable to move much but can move his fingers and talk. He activates his smartphone to call 911 and activate noise generating and lights on his illuminating jacket to send SOS visual signals to security and emergency responding personnel. Vehicle lights can also be activated to serve such an emergency response.

It is to be understood that the above description is intended to be illustrative and not restrictive. For example, the above-described embodiments (and/or aspects thereof) may be used in combination with each other. In addition, many modifications may be made to adapt a particular situation, method, system device or material to the teachings of the various embodiments of the invention without departing from their scope. While the particulars and details described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements or steps that do not differ from the literal language of the claims, or if the examples include equivalent structural elements or steps with insubstantial differences from the literal language of the claims.

We claim:

1. A communication device comprising a touch-sensitive hand-wearable and a controller, wherein the hand-wearable device is made of an electrically conductive material.

2. The device of claim 1, wherein the hand-wearable is a mount for at least one of two-wheel vehicles handlebar and pet reins/leash.

3. The device of claim 1, wherein the hand-wearable communicates using wires with the controller.

4. The device of claim 1, wherein the hand-wearable communicates wirelessly with the controller.

5. The device of claim 1, wherein the hand-wearable controls, communicates via finger touching other fingers of the same wearable.

6. The device of claim 1, wherein the hand-wearable controls communication via finger touching another device mounted on at least one of the selected from the group consisting of the handle of motorbikes, bikes, remote-control, and pet reins/leash.

7. The device of claim 1, wherein the hand-wearable is made of one or more metals selected from the group consisting of bronze, brass, copper, silver, gold, nickel, aluminum, and any combination thereof.

8. The device of claim 1, wherein the hand-wearable is flexible, stretchable, bendable, and one size fits all hands sizes.

9. The device of claim 1, wherein the device has one or more kill switch(s) to conserve battery charge.

10. The device of claim 1, wherein the device communicates wirelessly with one or more wearable technologies selected from the group consisting of the vest, jacket, legwear, pants, headwear, neckwear, socks, shoes, footwear, and jewelry.

11. The device of claim 1, wherein the device communicates wirelessly with one or more electronic devices selected from a group consisting of a speaker, microphone, cellular phone, camera, and vehicle.

12. The device of claim 1, wherein the device communicates wirelessly with others wearing the touch-sensitive hand device.

13. The device of claim 1, wherein the device communicates wirelessly with wearables on animals selected from a group consisting of dogs, cats, horses, rabbits, ferrets, bovine, pigs, rodents, hamsters, gerbils, chinchillas, rats, and Guinean pigs.

14. The device of claim 1, wherein the device is weather-, water-, temperature-, humidity-resistance or -proof and any combination thereof.

15. The device of claim 1, wherein the device communicates wirelessly with a speaker to deliver voice command instruction to other electronic devices.

16. The device of claim 1, wherein the device can be re-charged via one or more selected from the group consisting of wired mode, wireless mode, solar mode, and a combination of any modes.

17. The device of claim 1, wherein the device has 1 to 10 channel receivers.

18. The device of claim 1, wherein the device is trackable.

19. The device of claim 1, wherein the device is operated and controlled by an app/APP.

20. The device of claim 1, wherein the device has at least one or more micro-USB and USB port.
